(19) United States
(12) Patent Application Publication
(10) Pub. No.: US 2010/0280861 A1
(43) Pub. Date: Nov. 4, 2010

(54) Service Level Agreement Negotiation and Associated Methods

(76) Inventors: Lars Rossen, Palo Alto, CA (US); Amitay Korn, Kfar Vradim (IL)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/433,777

(22) Filed: Apr. 30, 2009

(51) Int. Cl. G06Q 10/00; G06N 7/02

(52) U.S. Cl. 705/7; 706/52

(57) ABSTRACT

A method for minimizing risk of a service level agreement (SLA) is provided. Such a method can include creating a risk profile for a key performance indicator based on a collection of data, determining a service level objective (SLO) cost for a SLO by correlating the SLO with the risk profile, and computing a cost of a SLA by analyzing the SLO cost for the SLO associated with the SLA.

### BACKGROUND

As the information technology (IT) needs of businesses grow and become more complex, the desire to formalize the relationship between a business and an IT provider increases. Such a relationship is often characterized through a Service Level Agreement (SLA). An SLA is often a negotiated contract pertaining to a common understanding between the parties to an IT provider agreement regarding services, priorities, responsibilities, guarantees, penalties, and warranties. Various levels of service can be established that can provide both parties with an expectation regarding the services provided.

Creating a reasonable provider-consumer SLA is not trivial. Estimation of costs for providing a given level of service can be difficult, thus potentially increasing the complexity of the negotiation process. Additionally, some Service Level Objectives (SLOs) can be provider-driven while others can be consumer-driven, thus further increasing potential SLA complexity. For example, some SLAs are provided to a consumer as a pre-designed set of service level choices each having an associated service price. While the consumer is allowed to choose a given level of service, that choice may not be optimal to meet specific business needs of the consumer. Alternatively, a consumer can provide the service provider with a set of service expectations for which the service provider will design services. Neither of these situations is optimal given the unique and complex nature of many businesses utilizing these services.

### BRIEF DESCRIPTION OF THE DRAWINGS

FIG. 1 is a flow chart depicting a method for minimizing risk of a service level agreement in accordance with one embodiment;

FIG. 2 is a flow chart depicting a method for minimizing risk of a service level agreement in accordance with another embodiment;

FIG. 3 is a schematic representation of a system used for minimizing risk of a service level agreement in accordance with yet another embodiment; and

FIG. 4 is a schematic representation of a software module in accordance with a further embodiment.

### DETAILED DESCRIPTION

Features and advantages of the embodiments will be apparent from the detailed description which follows, taken in conjunction with the accompanying drawings, which together illustrate, by way of example, features of the embodiments.

One issue that arises in the negotiation of a Service Level Agreement (SLA) pertains to the different backgrounds and focus of the parties to the negotiation. Often these negotiations are between a consumer entity made up primarily of business people, and a provider entity made up of primarily IT people. In general, business people understand the working of the business they are running, while IT people understand the technical aspects of the IT system. Negotiations between these rather diverse groups have previously been accomplished using guesswork and estimations of perceived needs. Costs for an SLA resulting from such a negotiation are difficult to correctly determine, so the risks in entering into such an agreement can be high for both parties. One potential benefit of the present methods includes the formalization of how an SLA is formulated so that the complicated technical nature of the Service Level Objective (SLO) and how it relates to underlying Key Performance Indicators (KPIs) can be separated from the business aspect of selecting and grading relevant SLOs to include in an SLA. It can thus be useful to define the demarcation between the technical aspect and the business aspect of an SLA.

One issue with many “provider-driven” approaches is that they often do not capture the real needs of the consumer or the real business impact of an SLA violation. As such, the real business risk associated with the service delivery may not be taken into account. Alternatively, in many consumer-driven approaches, a provider may be apportioned a disproportionally large portion of the risk because it can be so difficult to effectively validate the risk associated with an SLA.

The present methods perform such negotiations that reduce the risk of entering into such an agreement by separating the business related discussion and understanding from the IT discussion and understanding. The method allows risk to be managed in a way that is reasonable and well organized with respect to the service delivery architecture. The method additionally allows business people to easily access and model the SLA, and thus the method is able to overcome the disparate backgrounds and understandings of the negotiating parties.

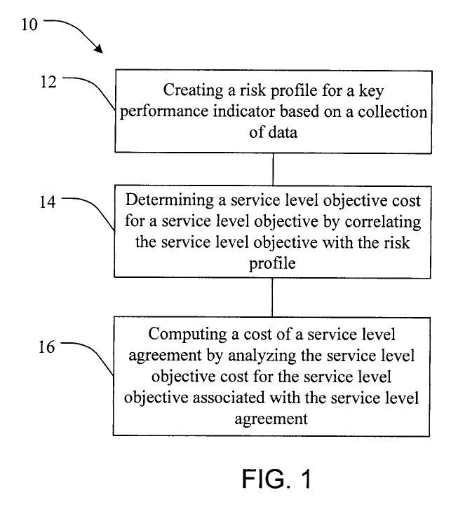

In one aspect shown in FIG. 1, a method 10 for minimizing the risk of a Service Level Agreement (SLA) is provided. Such a method can include creating a risk profile for a Key Performance Indicator (KPI) based on a collection of data 12. Accordingly, the risk profile can allow an estimation of the risk for a particular KPI. The method further includes determining a Service Level Objective (SLO) cost for a SLO by correlating the SLO with the risk profile 14. Such a correlation allows a risk probability to be determined for each SLO having a risk profile associated therewith. In some aspects, a statistical probability of failure of the SLO can be determined. Subsequently, a cost of a SLA can then be computed by evaluating the SLO cost for the SLO associated with the SLA 16.

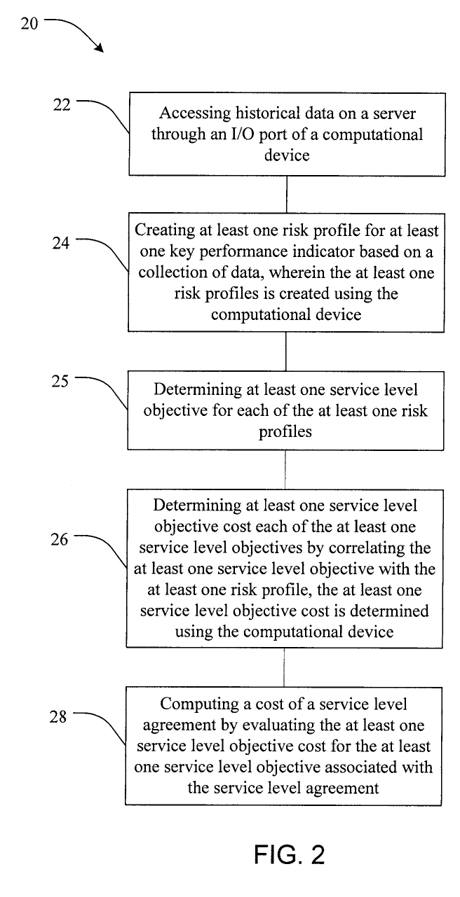

In another aspect shown in FIG. 2, a method 20 for minimizing risk of a SLA is provided. Such a method can include accessing historical data on a server through an I/O port of a computational device 22 and creating at least one risk profile for a KPI or KPIs based on a collection of data. The risk profile(s) are created using the computational device 24. Subsequently, at least one SLO can be determined for each of the risk profile(s) 25, and at least one SLO cost can be determined for each of the SLO(s) by correlating the SLO(s) with the risk profile(s) 26. The SLO cost can also be determined using the computational device. Also, a cost of the SLA can be computed by evaluating the SLO cost for the SLO(s) associated with the SLA.

It should be noted that analyzing the SLO cost can include any analysis method known to one of ordinary skill in the art. In a situation where a single SLO is associated with a SLA, analyzing may include merely noting the cost of the SLO. In a situation where multiple SLO costs are associated with a SLA, analyzing may include summing the costs for all the necessary SLOs. In the situation where various SLO cost options are available, analyzing might include selecting a collection of SLO costs that provide the lowest overall SLA cost, or even the lowest overall cost that provides a desired level of service.

Additionally, a KPI can be defined as a metric that is used to assess the performance of the service provider in quantifiable terms. As such, a KPI can be used to monitor whether the SLOs are being fulfilled according the provisions of the SLA. Examples of KPIs can include, without limitation, metrics such as queue times, throughput speeds, bandwidth, service time turn around, and the like.

Furthermore, a SLO can be defined as an element of a SLA between a service provider and an entity receiving the IT or other service. This entity will be referred to herein as a consumer. A SLO is an agreed upon element of the SLA that can be used to delineate a breach condition. For example, one possible SLO could define that query queue times be no longer than 10 ms, and that a breach occurs if more than five 10 ms query queue times occur during a given period. Another example can include a metric such as 90% of calls to a helpdesk are answered within 1 minute, and a breach occurs if 10 calls per month take longer than 1 minute to be answered. The Service Level Agreement (SLA) can further specify that if for every breach of that particular Service Level Objective (SLO) a percentage of the cost of the SLA is returned to the consumer. SLOs are, therefore, means of quantifying performance between the provider and the consumer as a way of avoiding disputes based on misunderstanding. SLOs are thus measurable metrics such as availability, throughput, frequency, response time, quantity, and the like. Furthermore, a given SLA can have a single SLO or multiple SLOs.

A risk profile is a profile for measuring risk associated with a Key Performance Indicators (KPI) given the IT resources of the service provider. Such a risk profile allows the provider to assess the probable cost for delivering a level of service at a given level of risk. For example, if the KPI is call center queue wait time, then one possible risk profile may be the distribution of possible wait times correlated with the number of telephone operators in the call center. In this case the wait times will generally decrease as the number of operators increase. As such, the probability of queue times can be determined for a given number of operators. Conversely, the number of operators needed to support a consumer's desired queue time can be calculated for an acceptable level of risk to the provider. Also, a KPI can have any number of risk profiles correlating different aspects of the IT resources. For the above example KPI, additional risk profiles could include any metric that affected support call queue times. Specific non-limiting examples could include the type of equipment each operator uses, database accessibility, the number of call lines available to each operator, and the like.

In one aspect, the risk profile is calculated using a collection of data. The collection of data can be accessed over a network connection to a data server. As such, a user can retrieve the collection of data from the data server and create the risk profile on a computational device such as a computer. A variety of data forms are contemplated, and any useful form of data should be considered to be within the present scope. For example, in one aspect the collection of data is historical data. Using historical data can result in risk profiles having a high degree of accuracy. The historical data can be obtained from a variety of sources, including historical data from the service provider creating the risk profiles, historical data from other service providers, or a combination of historical data from the service provider creating the risk profiles and other service providers.

In another aspect, the collection of data can be estimated data. Estimated data can be useful for service providers that do not possess sufficient amounts of historical data to generate accurate risk profiles. Estimated data can also be useful in situations where the service level desired by the consumer is outside of the historical data of the service provider. For example, if a consumer needs a Service Level Objective (SLO) for data requests being processed in less than 10 ms and the provider has historical data from 20 ms to 100 ms, estimated data can be utilized to create a risk profile for processing times of less than 20 ms. Estimated data can be generated from similar existing data, or it can be generated using relevant known data patterns.

Additionally, in some aspects it can also be useful for the collection of data to include both historical and estimated data. This situation can arise for service providers that have some historical data, and where that historical data is insufficient in quantity to create a risk profile having a high degree of accuracy. In such a situation, estimated data can be used to supplement the historical data to create the risk profiles. Such a combination of data can also be useful in situations where there is sufficient historical data for creation of a portion of the risk profile, but not for creation of the entire risk profile range. Returning to the data processing example described above, historical data can be utilized to create the portion of the risk profile from 20 ms to 100 ms, and estimated data can be utilized to create the portion below 20 ms. In situations such as these, the historical data can be used to assist in creating the estimated data by using various data extrapolation techniques.

As has been described, a risk profile can be utilized in determining an SLO cost for the SLO being implemented or being considered for implementation under the SLA. The risk profile may display a range of a resource, such as the potential number of operators in a call center, along with a probable queue time for each point of the range (i.e. each point representing a different number of operators). Thus, the cost for a particular queue time objective can be estimated from the risk profile. In one aspect, determining the cost of the SLO can be merely looking up the desired service level in the profile and noting the resources needed for that service level at an acceptable risk level. The SLO cost can then be calculated from the number of required resources. In another aspect, a plurality of potential SLO costs could be calculated for different resources or resource alterations that would help in attaining the SLO. In this case, a single SLO or a combination of SLOs can be selected and the cost computed from there.

It should be noted that in many situations, the service provider would be in the best position to generate the risk profiles and calculate Service Level Objective (SLO) costs. However, in some aspects, it is also contemplated that the risk profiles and the SLO costs may be generated by the consumer and presented to the service provider. Similarly, the consumer would most likely be in the best position to compute the cost of a Service Level Agreement (SLA) from the consumer's perspective. In some aspects, however, the cost of the SLA could be computed by the provider and presented to the consumer.

As has been described, the present method defines a SLO in terms of a collection of data to be defined through a breach function with a risk profile. This can be formalized by considering the SLA to be a collection of SLO categories (K), as is shown in Equation (I):

SLA={i: 1 . . . n|Kᵢ} (I)

where each category is constructed as a set of SLOs, as is shown in Equation (II):

Kᵢ={j: 1 . . . nᵢ|SLOᵢⱼ} (II)

The definition of the available categories and their associated SLOs is determined by the service being delivered. This is a technical determination that can be measured and determined prior to a business discussion. The business discussion is likely to include what the nature of the SLO is, or rather, what constitutes and SLA violation.

One component to a negotiation between the service provider and the consumer is the business cost associated with a violation. It can be difficult to define and negotiate how the SLO should be expressed in terms of the underlying Key Performance Indicators (KPI) that forms the basis for the SLO calculation. One possible standardized method of expressing a SLO whereby the SLO is calculated as being in violation of the underlying KPI is if there are more than a defined number of breaches during an SLA period, which is expressed as shown in Equation (III):

SLOᵢⱼ=B_{KPIij}>Cᵢⱼ (III)

where B_{KPIij} is a breach function and Cᵢⱼ is the allowed number of breaches under the SLA during the SLA period. As an example, B_{KPIij} could be a function whereby application response time must be 2 seconds or less for 95% of the search requests performed in a business day. Cᵢⱼ therefore may be a maximum of two breaches during a Service Level Agreement (SLA) period of one month.

It should be noted that the breach function can be described as the separation point between the service provider (technical) and the consumer (business) aspects of a SLA contract. Accordingly, from a business perspective the SLA can be negotiated in two steps: 1) negotiation of how many breaches should be allowed to happen in an SLA period (Cᵢⱼ values), and 2) negotiation to assign a weight or importance to each Service

Level Objective (SLO) and Category K so that a consolidated SLA violation can be deterministically calculated at each SLA period. Such weighting function is shown in Equations (IV) and (V):

|SLA|=Σ(Kᵢ*Wᵢ)/Σ(Wᵢ) (IV)

|Kᵢ|=Σ(SLOᵢⱼ*Pᵢⱼ)/Σ(Pᵢ) (V)

where P and Ware weights that indicate the relative importance of the SLO or Category K.

The business negotiation is to agree on the P, W, and C values. Then the consumer can assign a cost or penalty to the degree of violation of the contract. Such a calculation is easily performed in a variety of business applications, such as a spreadsheet, and the technical details of the calculations can be provided by the service provider.

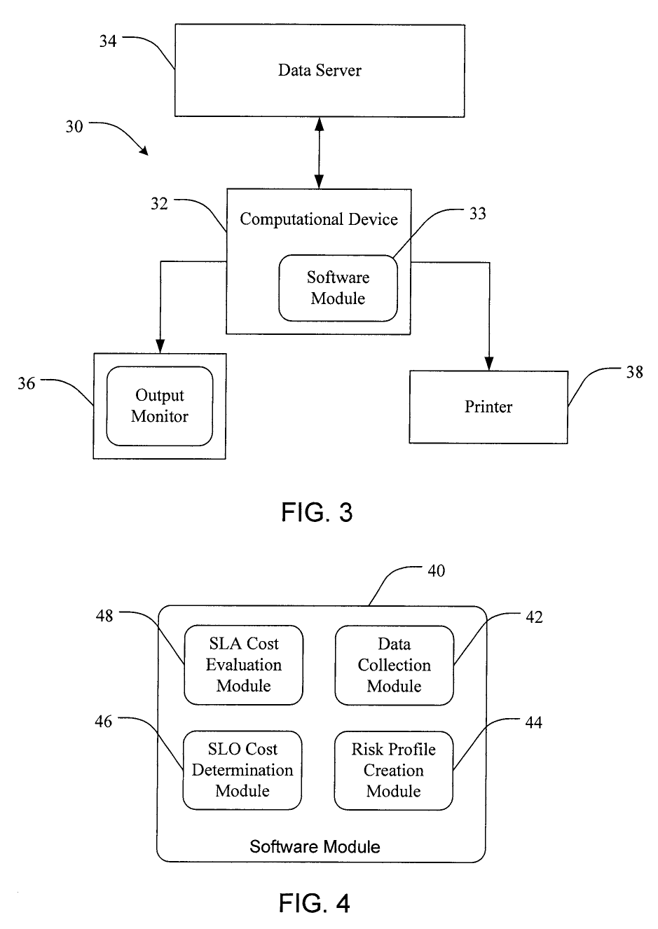

The methods according to aspects of the present invention can be performed using a variety of computing devices. For example, FIG. 3 shows a system 30 including a computational device 32. The computational device contains a software module(s) 33 for compiling the collection of data, creating the risk profiles, and calculating SLO costs. As has been described, a collection of data can be retrieved from a networked data server 34 by the computational device. Other optional peripherals include an output monitor 36 and a printer 38 that can be used to display risk profiles, SLO calculations, cost estimations, and the like.

A variety of components of the software module are contemplated, as is shown in FIG. 4. For example, the software module 40 can include a data collection module 42 that is operable to access and retrieve the collection of data from a networked server. The collection of data can be processed by a risk profile creation module 44 to generate a risk profile. The risk profile can then be utilized by a SLO cost determination module 46 in order to determine an SLO cost for an SLO associated with a the risk profile. Subsequently, a SLA cost evaluation module 48 can be utilized to evaluate the cost of the SLA based on the SLO costs.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A method for minimizing risk for a service level agreement, comprising:
creating a risk profile for a key performance indicator based on a collection of data;
determining a service level objective cost for a service level objective by correlating the service level objective with the risk profile; and
computing a cost of a service level agreement by analyzing the service level objective cost for the service level objective associated with the service level agreement.

2. The method of claim 1, further comprising creating the risk profile on a computing device and accessing the collection of data on a server over a network.

3. The method of claim 1, wherein the collection of data is historical data.

4. The method of claim 1, wherein the collection of data is estimated data.

5. The method of claim 4, wherein the estimated data is based on known data patterns.

6. The method of claim 1, wherein creating the risk profile for the key performance indicator further includes creating a plurality of risk profiles for at least one key performance indicator based on the collection of data.

7. The method of claim 1, wherein determining the service level objective cost for the service level objective further includes determining a plurality of service level objective costs for a plurality of service level objectives by correlating each of the service level objectives with an associated risk profile.

8. The method of claim 1, wherein computing the cost of a service level agreement further includes:
generating a plurality of service level objective costs for a plurality of service level objectives associated with a plurality of potential service level agreements; and
selecting the service level agreement from the plurality of potential service level agreements based on the plurality of service level objective costs.

9. The method of claim 1, wherein the risk profile includes a statistical probability of failure of the service level objective.

10. The method of claim 1, wherein the risk profile and the service level objective cost are created by a provider entity.

11. The method of claim 1, wherein computing the cost of the service level agreement is performed by a consumer entity.

12. The method of claim 11, wherein a plurality of service level objective costs is provided to the consumer entity for computing the cost of the service level agreement.

13. A method for minimizing risk for a service level agreement, comprising:
accessing historical data on a server through a communication channel of a computational device;
creating at least one risk profile for at least one key performance indicator based on the historical data, wherein the at least one risk profiles is created using the computational device;
determining at least one service level objective for each of the at least one risk profiles;
determining at least one service level objective cost for each of the at least one service level objectives by correlating the at least one service level objective with the at least one risk profile, the at least one service level objective cost being determined using the computational device; and
computing a cost of a service level agreement by evaluating the at least one service level objective cost for the at least one service level objective associated with the service level agreement.

14. The method of claim 13, further comprising:
computing the cost of a plurality of service level agreements; and
selecting a preferred service level agreement based on the computed cost.

15. The method of claim 13, wherein the at least one risk profile includes a statistical probability of failure of the at least one service level objective.

16. The method of claim 13, wherein the at least one risk profile and the at least one service level objective cost are created by a provider entity.

17. The method of claim 13, wherein computing the cost of the service level agreement is performed by a consumer entity.

18. The method of claim 17, wherein a plurality of service level objective costs is provided to the consumer entity for computing the cost of the service level agreement.

19. A system for minimizing risk for a service level agreement, comprising:
a computational device networked through a communication channel to a server containing historical data;
a software module resident on the computational device, the software module further comprising:
a data collection module operable to access and retrieve the historical data from the server;
a risk profile creation module operable to generate a risk profile from the historical data;
a service level objective cost determination module operable to determine a service level objective cost for a service level objective by correlating the service level objective with the risk profile; and
a service level agreement cost evaluation module operable to evaluate a service level agreement cost based on the service level objective cost.
